(19) United States
(12) Patent Application Publication
(10) Pub. No.: US 2021/0264555 A1
(43) Pub. Date: Aug. 26, 2021

(54) ELECTRONIC FINANCIAL TRANSACTIONS FOR A TABLE GAME WITH DELAYED PRINTING

(71) Applicant: AUTOMATED CASHLESS SYSTEMS, INC., Reno, NV (US)

(72) Inventors: Stephen L. Warner, Zephyr Cove, NV (US); Michael Sackrison, Reno, NV (US); Shawn G. Quick, Reno, NV (US)

(21) Appl. No.: 17/185,893

(22) Filed: Feb. 25, 2021

Related U.S. Application Data
(63) Continuation-in-part of application No. 15/212,020, filed on Jul. 15, 2016.
(60) Provisional application No. 62/193,586, filed on Jul. 17, 2015.

(51) Int. Cl. G06Q 50/34; G06Q 20/02; G06Q 20/40; G07F 17/32

(52) U.S. Cl. CPC G06Q 50/34; G06Q 20/027; G07F 17/3241; G07F 17/3244; G06Q 20/409

(57) ABSTRACT

A transactional system for a table game is described. The transactional system includes a controller, a wireless device, a database module, a payment gateway, and a transaction summary. The controller and the wireless device are associated with the table game. The wireless device is communicatively coupled to the controller, which is communicatively coupled to the database module and the payment gateway. The wireless device receives at least one transactional input that initiates a transaction. The wireless device communicates a plurality of transactional data corresponding to the initiated transaction through the controller to the payment gateway. The payment gateway communicates with at least one financial network and transmits an authorization response back through the controller to the wireless device, as well as to the database module. The database module stores the authorization response in association with a transaction record. The controller then generates a transaction summary for a time period.

### CROSS REFERENCE

This patent application is a Continuation-In-Part of patent application Ser. No. 15/212,020 entitled FINANCIAL TRANSACTIONAL GATEWAY SYSTEMS AND METHODS, filed on Jul. 15, 2016,

which claims the benefit of provisional patent application 62/193,586 entitled GAMING GATEWAY SYSTEM AND METHOD filed on Jul. 17, 2015;

and all the patent applications identified above are incorporated by reference in this patent application filing.

### FIELD

The present disclosure relates to a transactional system and method for a table game. More specifically, the transactional system and method includes a controller that communicates an authorization response to the wireless device that initiated a transaction; the controller also communicates the authorization response to a printer that generates an indicia of value at the table game; and a receipt is also printed at the wireless device.

### BACKGROUND

In everyday retail POS transactions, a merchant uses software that automatically transmits an authorization request to a credit or debit card processor which routes that request to the proper banking network. Because the banks essentially own the cards that the consumer uses, the banks then make a decision based on various factors relating to the transaction, such as amount, location, and/or daily limits to make a decision on whether the transaction request is approved or denied. In some cases, even an ‘overdraft’ is allowed because the bank deems the customer credit worthy and will approve the transaction even though the customer's account will become overdrawn. Typically, this also results in an overdraft fee charged to the customer.

Most casinos provide automated teller machines (ATM) and cash kiosks for the convenience of their patrons. However, these devices require floor space and often create a queue of patrons waiting in line to use the machines. Generally, these devices are dedicated machines that dispense cash to patrons and are usually located around the periphery of the casino floor. These devices are intended to be operated at one location and are not easily relocated. These devices also force players to travel to the location of the machine.

Additionally, existing unattended cash machines are expensive and may require considerable attention from gaming establishment personnel. Such machines must be continually restocked with large quantities of cash due to the near-continual use by patrons, which may also result in an increased frequency of machine failure.

Casino chips are commonly used at gaming tables in the casino property. Patrons may obtain chips for cash when beginning or continuing play at a table, but such purchases are limited to cash on hand and many players are reluctant to carry a large quantity of cash on their person. Patrons seeking to complete an electronic funds transfer (EFT) must therefore leave their table gaming station and seek out an ATM, cash kiosk, or often stand in line at the casino cashier's cage to perform that operation. Further, the patron may only be able to directly receive cash as the result of an EFT. To participate in most table games, the patron must then convert the cash into casino chips at either the cashier's cage or at the gaming table. Faced with the inconvenience of completing this two-step process, a patron may decide to stop playing, reducing the entertainment value of his gaming experience while simultaneously reducing revenue for the gaming establishment.

Automated Cash Systems, Inc. (ACS) has extended the reach of ATMs and kiosks to table games. More specifically, ACS provides a point-of-sale (POS) personal identification number (PIN) debit fund processing system for gaming patrons at table games. The ACS system provides a secure system that allows gaming patrons to initiate and complete an electronic transfer of funds from a bank or credit account entirely at the point of game play.

In the casino gaming space, there are many additional and varying regulations regarding all matters related to the operation of casinos, and the manufacture of devices used in casinos. These regulations are necessary in order to protect the consumer, the casinos and the reputation of the industry.

With respect to the customer, there are many challenges and concerns associated with “problem gaming.” Problem gaming may be referred to as a psychological condition, an impulse disorder, or simply an addiction. There are an estimated 1%-2% of those players that gamble that have a gaming problem as reported by the “National Center for Responsible Gaming” (NCRG).

Regulations also vary across the country and the world, as there is no federal or international regulation of the casino gaming space outside of online gaming. In the United States, each state is responsible for its own gaming regulations. Although many states have similar requirements, there are many differences in what those regulations allow, what devices may be used, and how those devices can be used. Further complicating the issue is the concept of the ‘sovereign nation’ status granted to Native American tribes by the Federal government that allows the tribes to regulate their own casinos within each state. This provides a greater number of bodies creating and enforcing casino gaming regulations.

Standard off the shelf POS hardware and software have only been designed to meet banking requirements. In addition, the ATM machines allowed on-site by casinos allow a customer to withdraw funds from his/her credit or debit card account, but provide no ‘gaming regulatory’ inspection or decision-making to obtain an approval. The machines simply provide cash if the customer's bank approves the transaction.

Gaming establishments are highly motivated to accommodate their patrons and increase player satisfaction. Thus, there is a need for a simplified method for a gaming patron to utilize their own instrument in a payment device located proximate to or at a table game, which can easily integrate with existing legacy casino gaming systems and meet the stringent security and regulatory requirements for casino gaming. Further, it would be beneficial to provide a secure system that allows gaming patrons to initiate and complete an electronic transfer of funds from a bank or credit account entirely at the point of game play, i.e. a table game.

### SUMMARY

A transactional system for a table game is described. The transactional system includes a controller, a wireless device, a database module, a payment gateway, a transaction summary, and an indicia of the transaction summary. The controller is communicatively coupled to the wireless device, both of which are associated with the table game. The wireless device receives at least one transactional input that initiates a transaction from the wireless device. The wireless device communicates a plurality of transactional data to the controller, wherein the transactional data corresponds to the transaction initiated by the wireless device. The database module is communicatively coupled to the controller and includes a transaction record that is unique to the table game. The payment gateway is communicatively coupled to the controller and communicates with at least one financial network. The controller communicates the transactional data received from the wireless device to the payment gateway, receives an authorization response from the payment gateway for an approved transaction, and communicates the authorization response to the database module. The database module stores the authorization response in association with the transaction record that is unique to the table game. The controller then communicates the authorization response to the wireless device, generates a transaction summary for a time period, and communicates the transaction summary for the time period to the database module.

In another embodiment, a transactional method for a table game is described. The transactional method begins by communicatively coupling a controller to a wireless device that are both associated with the table game. Then, the wireless device receives at least one transactional input that initiates a transaction from the wireless device. Next, a plurality of transaction data corresponding to the transaction initiated by the wireless device is communicated from the wireless device to the controller. Then, a database module including a transaction record unique to the table game is communicatively coupled to the controller. Further, a payment gateway that communicates with at least one financial network is communicatively coupled to the controller. Then, the received transactional data is communicated from the controller to the payment gateway. In response, the controller receives an authorization response from the payment gateway for an approved transaction. The controller communicates the authorization response to the database module. The database module stores the authorization response in association with the transaction record that is unique to the table game. The controller then communicates the authorization response to the wireless device. Lastly, the controller generates a transaction summary for a time period.

### FIGURES

The present invention will be more fully understood by reference to the following drawings which are presented for illustrative, not limiting, purposes.

FIG. 1 shows an architecture for an illustrative transactional system.

FIG. 2 shows a table game that includes the illustrative transactional system.

FIG. 3 shows a plurality of table games communicatively coupled to a server, in which each table includes the illustrative transactional system.

FIG. 4 shows a more detailed view of illustrative software modules associated with the server.

FIG. 5 shows a flowchart of a controller monitoring the data connections with a printer, EFT terminal, server and banking gateway.

FIGS. 6A-D show a flowchart of steps for processing a transaction using the transactional system.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized and structural changes may be made without departing from the scope of the claims.

In one embodiment, the transactional system and method permits a gaming patron to initiate and complete a transaction and receive indicia of value such as casino chips at the casino table game. More specifically, the illustrative transactional system and method dispenses an indicia of value to an attendant of the establishment, such as the dealer or croupier at a gaming table. The indicia of value may be a printed record that is used to provide casino chips that may be used by the player at the casino table game. Thus, the casino guest does not have to leave the gaming table to get additional cash, which would be then be converted to chips at the table. The transactional system and method presented herein operates without having to first receive cash from a conventional EFT process and subsequently convert the cash into casino gaming chips. A further aspect of the transactional system and method is the production and maintenance of a transaction summary for an elapsed time period.

Using Payment Card Industry (PCI) certified technology, the transaction is routed to the banking networks and a Ticket-In-Ticket-Out (TITO) ticket is printed using the printer already located at the game. The patron is then able to insert this ticket into the bill validator and an equivalent number of credits will be placed on the game register. Alternatively, the patron can choose to redeem this ticket for cash at any of the pre-existing redemption outlets.

In some embodiments, the systems and methods described herein use a proprietary financial network to route all transactions occurring at a casino property to a single backend server. The backend server has connections to both the banking and processing networks and to the Casino's Accounting and Management Software Infrastructure, which may also be referred to as the Casino Management System (CMS). The CMS use proprietary protocols and thus cannot be directly accessed by the backend server.

In order to provide a product that allows a gaming patron to use a financial instrument, such as a payment card (credit, debit, prepaid, or other method of transferring money), at a gaming device, a vendor must provide protections for the patron to comply with regulatory bodies and particular casino requirements. Further, the protections must demonstrate that the process is safe and secure, while providing complete accounting, privacy, and verification to meet all casino and banking regulatory requirements.

Further, regulatory requirements necessitate configuration of the various vendor provided protections, such as gaming limits and rules by or at each casino property. This capability is provided through a separation of functions between the backend server, which can be operated and controlled at and by each casino property, and one or more gateways that can be remote from all casino properties.

In the illustrative embodiment, the transactional system and method presented herein initiates, processes and completes an electronic funds transaction (EFT) or similar equivalent in a commercial environment. The transactional system and method may be used as a substitute for an automated teller machine (ATM), cash kiosk, or other such facility capable of completing the desired transaction. The transactional system and method is relatively small and portable, so the transactional system may be easily relocated.

In an illustrative embodiment, the transactional system and method operates at a casino table game. By way of example and not of limitation, the casino table game includes card games such as blackjack (also known as “21”), Poker, Pai Gow, Baccarat, and other such card games. Additional illustrative table games include, but are not limited to, wheel games such as roulette and dice games such as craps, Sic Bo and other such dice games.

In the illustrative embodiment, the transactional system and method does not dispense cash, like a typical Automated Teller Machine (ATM). In another embodiment, the transactional system and method dispenses other indicia of value, e.g., loyalty points or gift cards.

Another benefit of the transactional system and method may be easily relocated, e.g., to a patron's point-of-play, thereby facilitating game play. Additionally, the transactional system and method eliminates the need to restock an unattended ATM machine with cash. Furthermore, the transactional system and method operates with fewer complex mechanical components.

The term “indicia of value” as used herein includes an electronic record, a printed record and a physical token that has a relative worth, i.e. value, to the end user, e.g. customer or patron, and the business or property, e.g. casino. In other words, an electronic record may operate as an indicia of value. Also, a printed record may also operate as an indicia of value.

The indicia of value has a relative worth to the business or property, e.g. casino, and the end user, e.g. patron, in the transactional system and method for a table game that is presented herein.

An “electronic record operating as an indicia of value” is an electronic record that has relative worth to the end user and the business or property. There are a variety of secure communications that communicate an electronic record operating as an indicia of value in the transactional system and method for a table game.

An illustrative electronic record operating as an indicia of value includes the electronic record received from the wireless device, which securely communicates the electronic record to the controller. The controller then proceeds to transmit the electronic record operating as an indicia of value to the payment gateway, which further communicates the electronic record to the financial network or payment processor. The controller then receives an authorization response from the payment gateway. The authorization response is another electronic record operating as an indicia of value. The controller proceeds to transmit the authorization response to the wireless device. Again, the transmitted authorization response is an electronic record operating as an indicia of value.

A “receipt” for the approved transaction is presented at the wireless device. A receipt, i.e. payment record, provides a printed record that a payment was received by the business or property, e.g. casino, from the end user, e.g. patron. However, the receipt is not an electronic record and does not have relative worth. In other words, the receipt is a printed record that does not have an indicia of value.

An “electronic record” (by itself) provides electronic or digital evidence that a business activity or transaction took place at a particular time. The electronic record is captured through an electronic or digital process. An electronic record includes a records management solution, which controls the creation, distribution, use, maintenance and disposition of recorded information that is maintained as evidence of business activities or business transactions. Thus, an electronic record operating as an indicia of value is a subset of an electronic record. An electronic record may include other database attributes that are not specific to the electronic record operating as an indicia of value such as player loyalty information or accumulated loyalty points or player preferences and other such electronic records that are do not correspond to an indicia of value.

A “printed record operating as an indicia of value” is a printed record that has relative worth to the end user and the business or property utilizing the transactional system and method presented herein.

In general, a “voucher” is a printed document that has an indicia of value, which may be exchanged for goods, services, casino chips or any other indicia of value.

A “coupon” entitles the holder of the coupon to a discount for a particular product. A coupon is a type of voucher.

In gaming, the definition of a voucher is more granular because there are a variety of different vouchers including a complete voucher, a duplicate voucher, an incomplete voucher and replacement voucher. A “complete voucher” (in gaming) contains, at a minimum, a complete validation number and is of a quality that can be redeemed through the use of an automated reader or scanner. A “duplicate voucher” is any reprinted complete voucher or incomplete voucher. An “incomplete voucher” contains, at a minimum, the voucher validation number printed across the printed leading edge and is manually redeemable, but is not of a quality that can be redeemed through the use of an automated reader or scanner. A “replacement voucher” is printed following a failed attempt to print a complete or incomplete voucher.

A printed record operating as an indicia of value is different from a complete voucher, a duplicate voucher, an incomplete voucher and replacement voucher; however, the printed record operating as an indicia of value is a type of voucher.

The printed record voucher operates as an indicia of value because it provides a printed record of an “electronic buy in” transaction that can be tracked by the business or property. In the illustrative table game embodiment, the printed record voucher is printed by the illustrative printer when an “electronic buy in” transaction is completed; the dealer accesses the printed record voucher operating as an indicia of value and places the printed record voucher in the table game's cash chute.

The printed record voucher operating as an indicia of value is not a cash equivalent. The printed record voucher operating as an indicia of value may not be redeemed through the use of an automated reader or scanner. Additionally, the printed record voucher operating as an indicia of value may not be manually redeemable.

In the illustrative embodiment, a receipt is generated by the wireless printer. The wireless printer receipt is presented to the end user, e.g. customer or patron. The customer (not the property) is responsible for the receipt. The printed record voucher operating as an indicia of value is distinguishable from the customer receipt because the printed record voucher provides a record of the transaction initiated by the end user, in which the end user received the casino chips, i.e. a physical token operating as an indicia of value, after providing the appropriate “card” information, e.g. PIN.

An illustrative voucher system includes, but is not limited to, a Ticket-In-Ticket-Out (TITO) system. A TITO ticket is an illustrative complete voucher that can be redeemed through the use of automated reader or scanner. The illustrative voucher may be a PlayOn℠ voucher.

A “physical token operating as an indicia of value” is a physical token that has relative worth to the end user and the business or property. By way of example and not of limitation, casino chips, poker chips and gift cards are illustrative physical tokens operating as an indicia of value.

A “payment gateway” is also referred to interchangeably as the “banking gateway.” The payment gateway is configured to communicate with at least one financial network or payment processor. Additionally, the payment gateway is configured to receive an authorization request, which is associated with an approved transaction.

A “gaming gateway” is configured to manage and perform the regulatory requirements associated with gaming or gambling. By way of example and not of limitation, the gaming gateway may include problem gaming limits and problem gaming rule sets. Illustrative problem gaming rule sets may include daily limits or may pause the period during which a person may withdraw funds to allow for a “cool down” period. Additionally, the gaming gateway may be configured to communicate with a regulatory gateway that includes a variety of rule sets such as tribal rules, state gambling rules, federal gaming rules, casino property gaming rules and other such gaming or “gambling” rule sets. Gaming is used to refer to gambling.

The gaming rules and gaming limits may include a variety of factors used by the gateway to determine the applicability of a particular gaming limit or gaming rule. The gateway can apply one or more of the factors when determining the applicability of a particular gaming rule or gaming limit to a fund transfer request or transaction. These factors can include, but are not limited to, temporal factors, geographic factors, and identification factors. In operation, each gaming limit and gaming rule provides a restriction on the number of transactions or total value of transactions during a time period, within a particular location, and attributed to a particular identity. The various factors would then be used by the gateway to define the time period, such as a day, as a calendar day, a gaming day, or a trailing period of 24 hours. Further, the gateway can use the factors to define a particular location as within a 50 mile radius, within the boundary of a particular State, within the limits of a City, within a Zip Code, within one or more properties of a Gaming Entity, within a single casino property, on a certain floor of a casino, at a particular bank of gaming machines, at a particular gaming machine, at a particular table, or at a particular position of a particular table. Finally, the gateway can use the factors to define an identity to which a gaming rule or gaming limit applies, such as a particular patron or a particular debit instrument (i.e. per card).

For purposes of this patent, reference is also made to a master gateway, which includes the payment gateway and the gaming gateway.

The “transaction summary” is a record of transactions for a particular location occurring during a particular time period. The particular location may be a casino property, all tables at a casino property, a single table, or any combination thereof. The particular time period may be 1 hour, 1 day, 1 business day, 1 calendar day, a 24 hour period, or any other time period selected by a casino operator.

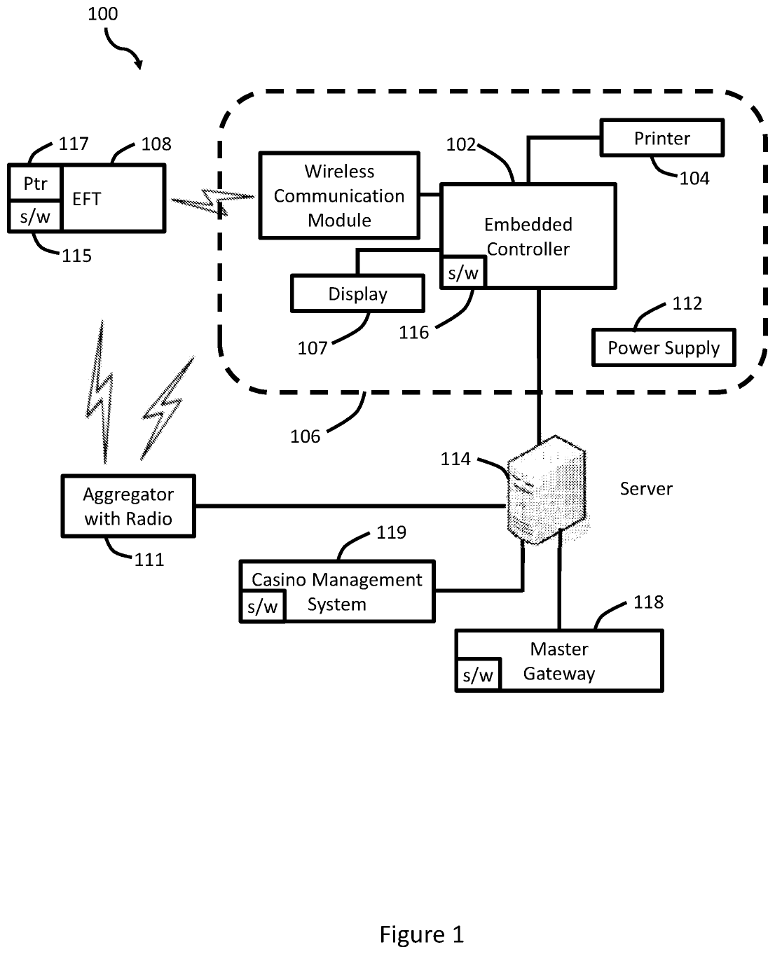

Referring to FIG. 1 there is shown an illustrative transactional system 100. The transactional system 100 includes a controller that is communicatively coupled to a printer. By way of example and not of limitation, a hard wire connection is made between an embedded controller 102 and a dedicated printer 104, which generates a printed record operating as an indicia of value. The combination of the embedded controller 102 and printer 104 may be enclosed in a printer box or housing 106.

By way of example and not of limitation, the embedded controller 102 may be embodied as an ARM based Linux embedded controller with USB and Ethernet connectivity to the printer 104. The illustrative printer 104 may be an Ithaca 950 printer or a Nanoptix NextGen™ that has a hardwire connection to the embedded controller 102. Alternatively, the printer has a secure wireless connection to the embedded controller 102. More specifically, the embedded controller 102 may be communicatively coupled to the printer 104 using a secure wireless communication channel that operates using a wireless communication protocol such as Wi-Fi, Bluetooth, DigiMesh, Zigbee, or other such wireless communication protocol.

In the illustrative embodiment, the embedded controller 102 includes a central processing unit (“CPU”), at least one static or random access memories, at least one port that permits connection of one or more external memories or data storage devices. For illustrative purposes, the CPU may include an ARM-based microprocessor, RISC microprocessor, or other such microprocessor suitable for the intended purpose.

The illustrative embedded controller 102 comprises one or more local device and network connectivity modules for communication using wired, wireless, near-field communications (NFC), other electromagnetic, fiber optic, other optical, or other communication means and/or protocols, including but not limited to USB (X).(Y), the proprietary Standard Peripheral Communication (“SPC”) protocol used in certain gaming devices, RS-232, RS-422, RS-485, IEEE 1394, wired Ethernet, Wi-Fi, 802.1(x)(y) compliant methods, Bluetooth™, infrared, optical, radio frequency, CDMA, GSM, GPRS, satellite, and the like. The network communication modules may include one or more ports enabled and associated with the network communication modules. The embedded controller may be configured to provide multiple ports that are simultaneously active using different protocols, multiple instances of the same protocol, or any combination thereof.

The illustrative embedded controller 102 operates under the control of an operating system such as, but not limited to, one based on the open-source Linux kernel with appropriate device drivers and other software necessary to securely implement transactional functionality presented herein. More generally, the embedded controller 102 may operate with any other suitable operating system based on open-source or proprietary software or firmware.

In the illustrative embodiment, the printer box 106 houses the embedded controller 102, a wireless communication module 110, the printer 104 and a power supply 112. The printer box 106 is disposed below or within an illustrative table game (not shown). The printer box 106 provides a single semi-portable enclosure. In some embodiments, the housing 106 is integrated into the table game so that a surface of the housing is visible to the dealer or casino personnel, for example the visible housing surface may be exposed to the dealer on a side portion of the table game in the dealer's area that is not visible to patrons. However, the housing 106 may be integrated into a table game so that the housing 106 is also visible to patrons at the table game, i.e. on the top surface of the table game or the gaming surface of the game. In these embodiments, a display 107 is disposed on the visible surface of the housing 106. The display 107 is communicatively coupled to the embedded controller 102 in order to receive transaction data relating to transaction requests and transmit dealer confirmations relating to authorized transactions.

In the illustrative embodiment, the printer box 106 provides a single enclosure or housing that includes the embedded controller 102 that is communicatively coupled to a dedicated printer 104. The embedded controller 102 and printer 104 communicate via a local communication protocol such as, but not limited to, RS-232, USB(X).(Y), SPC, RS-422, RS-485, IEEE 1394, or the like. By way of example and not of limitation, a protocol conversion interface or controller board may be utilized between the embedded controller 102 and the dedicated printer 104 to establish a secure data communication path between the two devices utilizing available or desired ports in each one. The dedicated printer includes any device suitable for generating a printed record operating as an indicia of value.

The illustrative printer box 106 may be quickly and easily relocated within an establishment as desired. A gaming property, such as a casino, may deploy such printer boxes 106 in locations where there is a demand for the transactional system and methods presented herein. Since the printer boxes 106 are semi-portable systems, the printer boxes 106 may be moved around to any location that has suitable AC power.

In some embodiments, the display 107 may include and/or be affixed to a stand rising out of the table game to provide a vertically oriented screen for display purposes. This display 107 may further be manipulable such that the screen can rotate on the stand both about a horizontal axis and/or about a vertical axis. The stand may be affixed directly to the printer box 106 or to the table game itself.

The embedded controller 102 and the dedicated printer 104 operate directly from conventional 120V AC power. One or more transformers, power supplies, power converters, or any suitable combination thereof are supplied and configured between the devices and the source of 120V AC power to provide power to the two devices with the required voltage and current availability for proper operation. Such combination of transformers, power supplies, and power converters may provide regulated or unregulated power to the devices.

An illustrative power supply 112 includes a 24V power supply unit that powers the printer 104. Additionally, the power supply includes a 25V to 5V voltage converter that powers the embedded controller, which in turn powers the wireless communication module 110.

The illustrative EFT terminal 108 is a wireless device that is powered by a rechargeable battery. For the purposes of this disclosure, the terms EFT terminal and Point of Sale (POS) terminal are used interchangeably. The EFT terminal 108 may operate in addition to, in association with, or as an alternative to the above described printer box 106 assembly. The EFT terminal 108 may be a stand-alone device, a portable device, and/or a handheld device.

The embedded controller 102, the dedicated printer 104, or the combination thereof operate for a limited time period utilizing a source of stored energy, such as an uninterruptable power supply (“UPS”), other battery configuration, charged capacitive storage device, or the like. Such stored energy devices charge automatically from an 120V AC power source when such power is available, but in the event of any interruption in such source, either or both device(s) continue to operate for a limited period of time using the stored energy. This is particularly advantageous to permit completion of any EFT in process at the time of an interruption in the commercial power service or if the subsystem should become inadvertently disconnected from AC power.

In the illustrative embodiment, the embedded controller 102 has a limited number of secure connections to other devices, thus a firewall is not required between the embedded controller 102 and the securely connected devices. Also, the illustrative embedded controller 102 constantly monitors and automatically detects any disconnection(s) and attempted reconnection(s). If any of the data connections are disconnected or otherwise inoperative, no transactions may be processed by the transactional system and method. For example, the embedded controller 102 securely communicates with the EFT terminal 108 and/or an aggregator 111 through the wireless communications module 110, and communicates with the master gateway 118 and/or a casino management system (CMS) 119 through the server 114 without the need for a firewall. Alternatively, at least one firewall may be disposed between the embedded controller and at least one of the data connections including, but not limited to, the EFT terminal 108, the master gateway 118 and the backend server 114; and the type of firewall is dependent on the type of data connection.

In some embodiments, the aggregator 111 receives wireless transmissions direct from the POS device 108 and routes them to the backend server 114 using an Ethernet protocol. Additionally, the aggregator 111 is configured to transmit the authorization and voucher validation information over the 802.15 wireless network. Furthermore, the data transmitted wirelessly across the network is encrypted with three (3) layers of data security that include tokenization, encryption from the controllers, and encryption from an alternate mesh protocol such as DIGIMESH™ which is developed by Digi International. DIGIMESH™ provides security using fixed AES-128 encryption that is configurable, but does not change during normal operation. The controllers each further encrypt the data using AES-128, but with keys that are different across all client device (i.e., POS device and/or EFT terminal 108) and aggregator 111 pairs and that change at least as often as each financial transaction. The third layer of security is provided by using a Derived Unique Key Per Transaction (DUKPT), which is a key management scheme that generates a unique key for every transaction wherein the unique key is derived from a fixed key.

In this embodiment, the EFT terminal 108 utilizes its on-board printer 117 to print vouchers and/or receipts for each transaction performed on the EFT terminal 108. The printer 117 may be a thermal printer printing onto a paper roll stored within or affixed to the EFT terminal 108. Thus, the EFT terminal 108 may operate as an alternative to the printer box 106 assembly, as well as in addition to the printer box 106 assembly.

In other embodiments, the EFT terminal 108 may relay patron input and transaction details to the wireless communication module 110, which communicates wirelessly with an aggregator 111 in order to transmit the patron input and transaction details to the master gateway 118.

The illustrative aggregator 111 is located at specific locations to minimize the need for individual radios, which creates the ability for the 802.15.4 network to handle many nearly simultaneous transactions. In operation, a preliminary path check ensures the ability of the network to fully route transactional information to the desired source.

The embedded controller 102 is also communicatively coupled to a wireless EFT device 108. The Electronic Funds Transfer (EFT) terminal 108 uses a wireless connection such as an IEEE 802.11 (WiFi), IEEE 802.15 (Bluetooth/Zigbee) or other such wireless communication standard. The EFT terminal may include a printer 117 for printing a receipt or other indicia of a transaction for the patron. The printer 117 may be a thermal printer that is used to print vouchers. The process of generating a secure communication between the embedded controller 102 and the EFT terminal 108 is performed by an EFT software module 115 communicating with an embedded controller software module 116. In the illustrative embodiment, the EFT software module 115 is configured to present the illustrative end user, e.g. casino patron, with user instructions.

More specifically, the illustrative EFT terminal 108 is a Blue Bamboo P200, which includes a PCI certified receipt printer, a PIN pad, an NFC contactless solution, an LCD display, an EMV card reader and a mag stripe card reader. The EMV card reader is compatible with the EMV global standard for authentication of credit and debit card transactions. The EFT terminal 108 may also include a payment card industry (PCI) and pin entry device (PED) certified device.

The Blue Bamboo P200 or other such compatible device includes proprietary software 115 that may be embodied as a STIPIet that conforms to the Global Platform Small Terminal Interoperability Platform (STIP) standard. The pre-encrypted data sent between the STIPIet or comparable application running on the EFT terminal 108 and the custom proprietary software application 116 running on the embedded controller may be encoded using a proprietary format. Even if the encryption of the data is broken, the plaintext format of the data will still be unknown. Alternative devices are configured to provide similar functionality as the STIPlet with a combination of firmware and software that operates on a device configured to perform the functions presented herein.

Another illustrative POS terminal is a YouTransactor SK100 which includes a PCI certified PIN pad, an NFC contactless solution, an LCD display, an EMV card reader and a mag stripe card reader. The EMV card reader is compatible with the EMV global standard for authentication of credit and debit card transactions. The POS terminal 248 may also include a payment card industry (PCI) and pin entry device (PED) certified device.

The YouTransactor SK100 or other such compatible device includes proprietary software 249 The pre-encrypted data sent between the custom software application or comparable application running on the POS terminal 248 and the custom proprietary software application 241 running on the slot controller 240 may be encoded using a proprietary format. Even if the encryption of the data is broken, the plaintext format of the data will still be unknown. Alternative devices are configured to provide similar functionality as the custom software application with a combination of firmware and software that operates on a device configured to perform the functions presented herein.

The wireless device, e.g. EFT terminal 108, includes a hardware module (not shown) that supports secure wireless communication using wireless communication protocols such as Bluetooth, DigiMesh, Zigbee, Wi-Fi and other such wireless communication protocols. Additionally, the embedded controller 102 is communicatively coupled to a wireless communication module 110, which is also configured to support secure wireless communication using wireless communication protocols such as Bluetooth, DigiMesh, Zigbee, WiFi and other such wireless communication protocols. Thus, the EFT terminal 108 can securely communicate with the wireless communication module 110 in a nearby table game (not shown) using one or more of such wireless communication protocols. In the illustrative embodiment, the wireless protocol is the 802.15.4 wireless protocol. Other illustrative wireless protocols include GSM/GPRS, CDMA, 802.11 and Bluetooth.

The wireless network is a protocol that uses the 802.15.4 standard and adds additional routing and networking functionality. Most notably, the invention adds mesh networking to the underlying 802.15.4 hardware module or radio. Mesh networking is used in applications where the range between two points may be beyond the range of the two radios located at those points, but intermediate radios are in place that could forward on any messages to and from the desired radios. The 802.15.4 network was designed for low power and low bandwidth applications. The software protocol may be used for high density locations such as casino gaming floors and public events.

The illustrative 802.15.4 network also supports the encryption that is necessary for processing financial transactions, confidential information and for system monitoring. The 802.15.4 wireless protocol operates at a frequency that is not readily discoverable by patrons.

Additionally, the illustrative network is configured to eliminate the need for user credentials so that each wireless communication module may use a unique AES key that changes before each transaction or after a period of expiration. The illustrative 802.15.4 wireless protocol enables client devices, systems and methods presented herein to use proprietary protocols that makes it difficult and/or cost prohibitive for a third party technology to communicate with the CMS system 119.

Additionally, the software protocol within the radios will take care of retries, acknowledgements and data message routing. Software also has the ability to self-heal the network. Devices in the network specification can forward all messages not intended for that particular device.

More generally, the wireless device 108 may comprise a central processing unit (“CPU”), one or more static or random access memories, and one or more ports to permit connection of one or more external memory or data storage devices. The wireless device may further include a point-of-sale (POS) personal identification number (PIN) entry keypad and one or more displays or display devices. The wireless device may include a payment card reader that may be a smart card reader, a magnetic card reader, a high-capacity optical storage media reader, a bar code, QR code, or other optical data storage reader, a punch card reader, a Braille reader, a contactless card reader, a proximity mobile payments reader that enables communication with smart phone devices, a contactless proximity card reader that processes secure smart ticketing and electronic payments using contactless secure mobile commerce technology, or any other device or system which retrieves information stored on or in a payment card or its functional equivalent. The wireless device may include one or more network connectivity modules for communication using wired, wireless, near-field communications (NFC), other electromagnetic, fiber optic, other optical, or other communication means and/or protocols, including but not limited to Wi-Fi, 802.1(x)(y) compliant methods, Bluetooth™, infrared, optical, radio frequency, CDMA, GSM, GPRS, and satellite. The network communication modules may include one or more ports enabled and associated with the network communication modules. Network connectivity may be achieved by the wireless device via any one or combination of several communication modules and communication modes based on operational situations. For example, the wireless device may communicate via a wired network using the appropriate wired communication module while the wireless device is placed in a wired connectivity cradle equipped with access to a wired network and the appropriate connector(s) to operatively communicate with a wired communication module port. When the wireless device is removed from the wired connectivity cradle, the wireless device may be switched from a wired communication mode to a wireless communication mode via activation and deactivation of the appropriate communication modules. The switch from wired to wireless communication mode may be performed automatically by software or firmware running on the wireless device or performed manually at the direction of a user. Similarly, the wireless device may automatically select or be manually instructed to utilize one of several available communication modules and modes to use based on operational factors such as, but not limited to, availability of service, signal strength, security considerations, available bandwidth, link reliability, and the like by activating desired communication module(s) and deactivating others. The wired connectivity cradle may also comprise a wireless access port operatively connected to the wired network and accessible by a wireless communication module in one or more wireless devices, thereby providing a localized point of network access for one or more wireless devices in a casino within which the electromagnetic spectrum may be highly congested and radio frequency interference is prevalent. The wireless device may comprise a printer and/or a printer port for connection of an external printer or a plurality of printers connected to a plurality of gaming devices via wired, wireless, or other communication means. The wireless device may be powered by alternating current, direct current, battery, stored charge, solar, or any other known power source available at the point of use. Wireless devices powered by stored energy sources may be periodically recharged from other power sources, including but not limited to charging a stored energy source when the wireless device is placed in a special cradle that may provide wired network connectivity as described above in addition to power charging capability.

In the illustrative embodiment, the embedded controller 102 does not perform payment functions; the payment functions are initiated by the EFT terminal 108. The embedded controller 102 securely transmits the requests from the EFT terminal 108. Since the embedded controller does not perform the payment function of generating the EFT request, there is little or no risk of a security breach resulting from the embedded controller 102 initiating a payment transaction. Thus, the wireless device, e.g. embedded controller 102, securely communicates a plurality of transactional data to the controller, wherein the transactional data corresponds to the transaction initiated by the wireless device.

The embedded controller 102 is also communicatively coupled to a “payment gateway,” which is referred to more specifically in this illustrative embodiment as the banking gateway 118. For purposes of this patent, the terms “payment gateway” and “banking gateway” are used interchangeably, however, in general the term “banking gateway” refers to the illustrative casino table embodiment and “payment gateway” refers to the more general embodiment. The payment gateway is configured to communicate with at least one financial network. Additionally, the payment gateway is configured to receive an authorization request, which is associated with an approved transaction.

A payment gateway software module, e.g. banking gateway software module 119, resides in the banking gateway 118 and includes proprietary software that communicates with the embedded controller 102. In the illustrative embodiment, the embedded controller 102 is communicatively coupled to a banking gateway API using a secure network communication protocol. The banking gateway 118 is communicatively coupled to one or more financial networks, including but not limited to the PLUS, STAR, CIRRUS, INTERLINK, MONEY PASS, or NYCE networks, that provide access to the server(s) associated with patrons' financial accounts.

By way of example and not of limitation, the embedded controller 102 is communicatively coupled to the banking gateway 118 using a wired Ethernet (TCP/IP) that employs an illustrative security protocol such as HTTPS utilizing SSL/TLS. Other security protocols may also be used. The HTTPS protocol provides authentication and protects the privacy and integrity of the exchanged data.

In the illustrative embodiment, the banking gateway software module 119, which resides in the banking gateway 118, includes proprietary software controlled by the banking gateway 118. More specifically, the banking gateway software module 119 includes a payment gateway API that is proprietary to at least one specific payment gateway service. In an alternative embodiment, the banking gateway 118 does not include the banking gateway software module 119; thus, the banking gateway 118 represents an external service associated with, but not controlled by, the transactional system.

In operation, the embedded controller 102 connects to and exchanges data with the external banking gateway 118. The transaction is initiated with an outbound EFT request, which is associated with a patron interacting with the wireless EFT terminal 108. Applicable data is forwarded from the wireless terminal 108 to the embedded controller 102, which is then sent to the banking gateway 118 and then to the appropriate financial network associated with the institution or other entity that manages and controls the patron's account. The result of the processed EFT request from the institution or entity is conveyed back to the banking gateway 118 via the financial network and then back to the embedded controller 102 for further disposition.

More generally, the payment gateway is communicatively coupled to the controller. The payment gateway securely communicates with at least one financial network. The controller securely communicates the received transactional data to the payment gateway. The controller then receives an authorization response from the payment gateway for an approved transaction. The controller communicates the authorization response to the wireless device, which presents a receipt for the approved transaction at the wireless device. Additionally, the controller 102 communicates the authorization response and associated transaction data to the server 114, which compiles transaction data for authorized transactions into a summary of transactions for a given time period, i.e. a transaction summary. Transaction summaries may be stored and/or compiled in a database module resident on the server 114. Alternatively, the controller 102 itself may compile transaction data for authorized transactions initiated through the particular controller 102 into a summary of transactions. By compiling transaction data in one or more transaction summaries, the transactional systems and methods may delay printing of an indicia of value, or entirely eliminate the step of printing an indicia of value. Thus, the indicia of value may be printed at a later time, after several transactions have been performed through the controller 102. When the indicia of value is printed at a later time, the controller may instruct the printer to print indicia of value for all transactions that occurred during a selected time period, such as the previous day, previous 24 hours, or some other time period beginning and ending prior to the time of printing. However, despite compiling transaction summaries on the server 114 or the controller 102, the controller 102 may communicate the authorization response to the printer 104, which generates a printed record operating as an indicia of value that corresponds to the transaction initiated by the wireless device. The printed record operating as an indicia of value is converted to at least one casino chip at the table game. As an alternative to, or in conjunction with printing an indicia of value at the printer 104, the controller 102 may communicate the authorization response to the display 107. The display 107 may then prompt a dealer or other casino employee to confirm the authorization prior to dispensing gaming chips or other indicia of value to the patron requesting the EFT.

In yet another embodiment, the payment/banking gateway also acts as a gaming regulatory gateway and adheres to limits, rules and standards that are set forth in accordance with specific gaming jurisdictions. The gateway may or may not handle rules and limits for more than one instance of the product simultaneously, such as handling rules of jurisdiction one for site 1 and rules of jurisdiction two for site 2. The gateway makes initial determinations based on these limits, rules and standards about whether a transaction should be processed and sent on to the financial network or rejected without being sent.

The payments gateway also has the ability to apply business based logic rules to initiated transactions. These parameters will determine the optimal transaction routing through the payment networks and can also determine whether or not to deny transactions based on pre-determined criteria.

In some embodiments the payment/banking gateway 118 is a master gateway. The master gateway includes or is communicatively coupled a database containing a plurality of gaming limits and gaming rules that each include a variety of factors used to determine the applicability of a particular gaming limit or gaming rule to a fund transfer request. These factors can include, but are not limited to, temporal factors, geographic factors, and identification factors. Each gaming limit and gaming rule provides a restriction on the number of transactions or total value of transactions during a time period, within a particular location, and attributed to a particular identity. The temporal factors provide granularity to the gaming limit or gaming rule time period, defining the time period of an hour as a trailing period of 60 minutes or 2:00 p.m. to 3:00 p.m., e.g., and defining the time period of a day as a calendar day, a gaming day, or a trailing period of 24 hours. The geographic factors provide granularity to the gaming limit or gaming rule location restriction such as by defining a location as any transactions occurring within a 50 mile radius, within the boundary of a particular State, within the limits of a City, within a Zip Code, within one or more properties of a Gaming Entity, within a single casino property, on a certain floor of a casino, at a particular bank of gaming machines, at a particular gaming machine, at a particular table, or at a particular position of a particular table. Further, the geographic factors may define a casino property as a particular casino location or any casino owned by a certain Gaming Entity, i.e. a particular legal entity such as a corporation. The identification factors provide granularity to the gaming limit or gaming rule identity restriction such as by defining that the gaming rule or gaming limit applies to a particular patron or a particular debit instrument (i.e. per card).

In one embodiment, the master gateway retrieves gaming limits and gaming rules applicable to a fund transfer request, such as by assessing the transaction information associated with the fund transfer request for the location from which the fund transfer request was made by a patron and determining that one or more tribal gaming rules, one or more state gaming rules, one or more federal gaming rules, or any combination thereof applies to the fund transfer request. The master gateway can also assess the transaction information associated with the fund transfer request for the identity of the patron making the request or the particular card associated with the request and determining that one or more gaming limit, such as a problem gaming limit, a House gaming limit, or a combination thereof applies to the fund transfer request.

The master gateway further retrieves transaction information for all other transactions related to the fund transfer request based upon the factors defining the applicable gaming limits and gaming rules, i.e. other transactions made by the same patron, or by the same patron within a certain time period. The master gateway can then make a determination of whether the fund transfer request is compliant or non-compliant with the applicable gaming limits and gaming rules.

The master gateway may be a hardware device that acts as a “gate” between two networks, which may be a router, firewall, server, or other device that enables traffic to flow in and out of the network. While a gateway protects the nodes within the network, it is also a node. The master gateway node may be on the edge of the network so that all data must flow through the master gateway before coming in or going out of the network. The master gateway may also translate data received from outside networks into a format or protocol recognized by devices within the internal network.

The master gateway may also be embodied as a router in an illustrative small network. A router allows computers within the local network to send and receive data over the Internet. A firewall is another type of gateway that filters inbound and outbound traffic, disallowing incoming data from suspicious or unauthorized sources. A proxy server is another type of gateway that uses a combination of hardware and software to filter traffic between two networks. For example, a proxy server may only allow local computers to access a list of authorized websites.

The illustrative server 114 may be a backend server or a computer that provides data to other computers. The backend server may serve data to systems on a local area network (LAN) or a wide area network (WAN) over the Internet. Many types of servers exist, including web servers, mail servers, and file servers. Each server is configured to run software specific to the purpose of the server. While server software is specific to the type of server, the hardware is not as important. In fact, a regular desktop computers can be turned into a server by adding the appropriate software. For example, a computer connected to a home network can be designated as a file server, print server, or both.

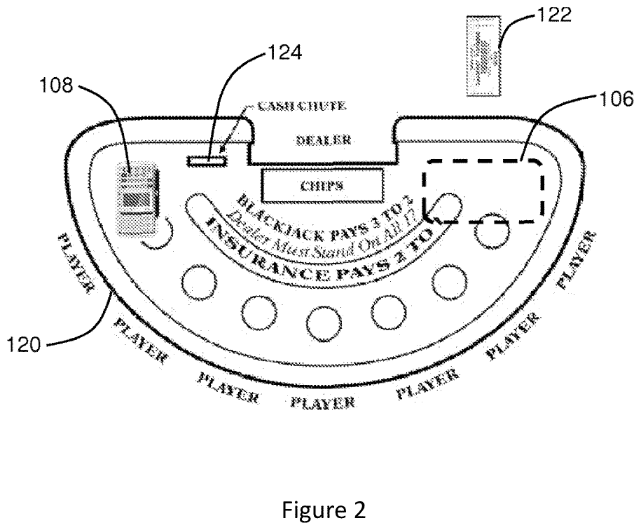

Referring to FIG. 2, there is shown an illustrative table game 120 that includes the transactional system 100. As described herein, the embedded controller 102 is wirelessly coupled to the wireless EFT terminal 108, which is disposed on the top or upper surface of the table game 120, i.e. the gaming surface.

The illustrative table game 120 is a Blackjack table. In table game 120, the printer box 106, which includes the embedded controller 102 and printer 104, is located below the table game 120. The table game also includes a wireless EFT terminal 108 that can be provided to players electing to make a debit transaction.

In some embodiments, when a transaction is approved, the printer 104 generates a printed record operating as an indicia of value 122 that is received by the dealer. The dealer then provides the player with the appropriate number of chips. The dealer then takes the printed record operating as an indicia of value 122 and places it within the cash chute 124. Thus, the cash chute 124 receives cash and the printed record operating as an indicia of value 122 printed by the printer box 106. In other embodiments, when a transaction is approved, the controller transmits the authorization to the display 107. The display presents an indication of the authorized EFT, which the dealer can confirm, i.e. by selecting or touching a confirmation/selection icon on the display 107. As discussed above, the printer 117 on the EFT terminal 108 may supplement or replace the printer 104 at a table game by performing one or more of the tasks identified and attributed to the printer 104 at the table game.

The printed record operating as an indicia of value 122 may contain alphanumeric text, symbols, holographic images, lenticular imagery, codes, images, fully or partially punched holes or other voids, intentional edge irregularity, Braille inscription, other intentional surface irregularities, promotional material, advertising material, other material or information depiction, or any combination thereof.

In the illustrative embodiment, the printed record operating as an indicia of value includes a ticket compatible in size and data format with the ubiquitous ticket-in, ticket-out (“TITO”) standard widely utilized in casino gaming systems. In another embodiment, the printed record operating as an indicia of value is compatible with re-writable data cards also known in the casino gaming industry. In yet another embodiment, the printed record operating as an indicia of value includes an article printed on paper or any other substrate media of desired composition and in any desired dimension or format as may be required to accommodate the establishment's preferred method of redemption.

In yet another embodiment, in lieu of providing the printed record operating as an indicia of value to an attendant of the establishment, the transactional system may issue an electronic credit to the establishment on behalf of the player. The value of the authorized electronic credit would then be remitted to the patron by an attendant of the establishment in some manner advantageous to the patron, including but not limited to cash, gaming chips, game play tokens, merchandise, services, or the like. The value may be remitted to the patron in any combination of the forms described above or in any other form desired by or acceptable to the patron, which collectively equals the value of the authorized electronic credit. As with the printed record operating as an indicia of value, the electronic credit is not dispensed directly to the patron but to the establishment or a designated attendant thereof for redemption and subsequent remittance to the patron.

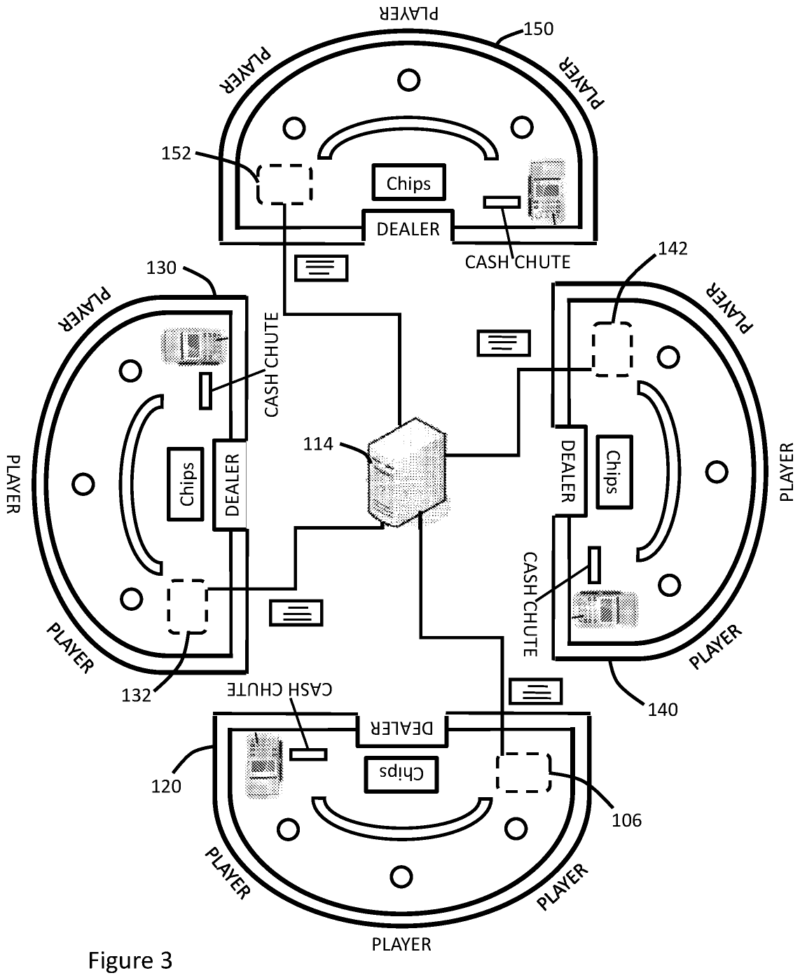

Referring to FIG. 3, there is shown a plurality of table games communicatively coupled to server 114, in which each table game includes the transactional system 100. More specifically, the table games 120, 130, 140 and 150 each include a printer box 106, 132, 142 and 152, respectively, which are communicatively coupled to server 114. In an alternative embodiment, a plurality of servers may also be communicatively coupled to a plurality of table games. The table games 120, 130, 140 and 150 are typically associated with a particular location in a casino property.

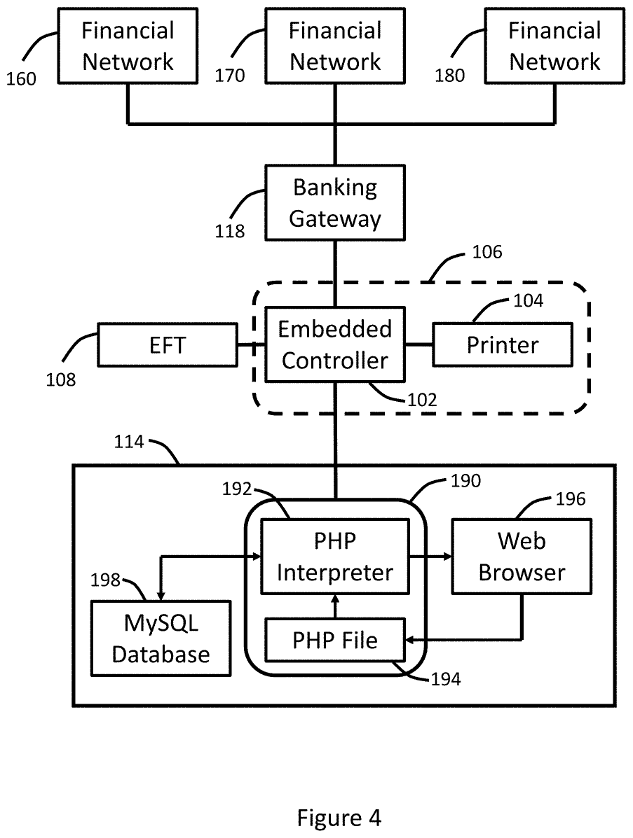

Referring to FIG. 4, there is shown a more detailed view of the illustrative software modules corresponding to the server 114. In the illustrative embodiment, the server 114 runs a Linux based operating system that includes an Apache web server 190, a PHP interpreter 192 and a mySQL relational database 198.

In the illustrative embodiment, PHP is server-side scripting language, which is interpreted on the web server 190 before a webpage is sent to a web browser 196 to be displayed on an administrator's client device. More specifically, the administrator accesses the web browser 196 and requests a dynamic PHP webpage file 194. The web server 190 recognizes the .php extension associated with the PHP webpage request 194 and passes the PHP file to the PHP Interpreter 192. The PHP Interpreter 192 then passes a SQL query to the MySQL database 198, which returns results for the PHP Interpreter 192. The PHP Interpreter 192 then produces a dynamic webpage that is displayed on the web browser 196. Alternatively, the server may use a Windows operating system running .NET tools and an MS-SQL relational database.

More generally, the server 114 may comprise standard computing hardware including a CPU, one or more static or random access memories, one or more magnetic or optical data storage devices, and one or more ports to permit connection of one or more external memories or data storage devices.

In another embodiment, the MySQL database may be embodied in a database server that is communicatively coupled to a web server. Authorized users may access the SQL database resident on the database server via HTTPS or other secure connection using conventional computing hardware via the web server.

In yet another embodiment, the database may be communicatively coupled remotely, via a secure SSL/TLS data path, or locally, via a secure local connection to a web server. Alternatively, the database server and web server may be combined in a consolidated server facility. System administrators, financial reconciliation or customer service personnel associated with the establishment, and other authorized users may access transactional system 100 data resident on database server via a secure connection to the web server. Such access may typically be provided by, but is not necessarily limited to, HTTPS connections utilizing SSL/TLS security.

Additionally, the transaction request that is initiated at the wireless EFT terminal 108 is securely processed by the transactional system 100 and transmitted to at least one of the financial networks 160, 170 and 180. In the illustrative embodiment, each financial network is communicatively coupled to one or more servers that correspond to a financial institution affiliated with the financial network.

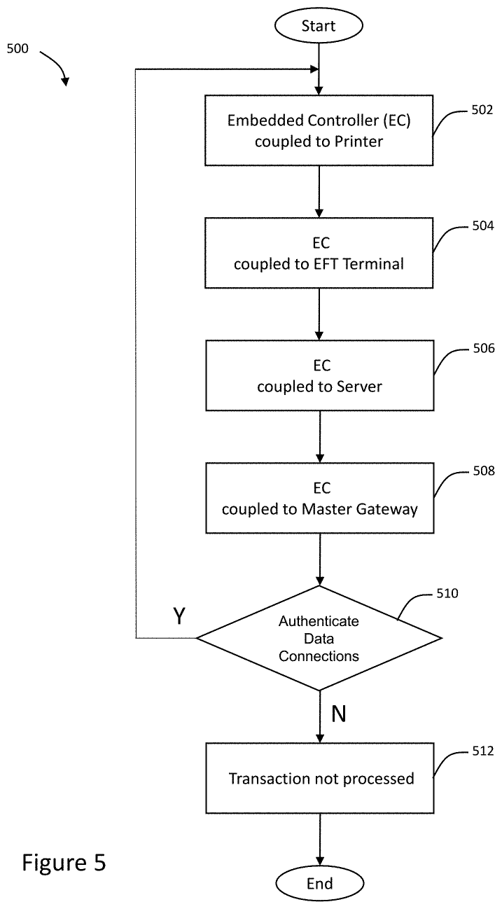

Referring to FIG. 5, there is shown a flowchart 500, in which the controller is establishing and monitoring the data connections with the printer, POS terminal, backend server, and master gateway.

Custom and proprietary software running on the controller establishes the three secure data connections that include: 1) a secure encrypted connection with the POS terminal, in which the necessary custom and proprietary software is active and configured to begin a new transaction; 2) a secure encrypted connection with the master gateway; and 3) a secure encrypted connection with the backend server. Once all three data connections are established by the controller, the transactional system is considered to be online, active, and accordingly, the illustrative POS terminal is available for a patron to initiate the transactional process.

At block 502, the controller 102 is communicatively coupled to the printer 104. In the illustrative embodiment, the controller 102 and printer 104 communicate via a local communication protocol such as, but not limited to, RS-232, USB(X).(Y), SPI, I2C, RS-422, RS-485, IEEE 1394, or the like. By way of example and not of limitation, a protocol conversion interface or controller board may be utilized between the controller 102 and the printer 104 to establish a secure data communication path between the two devices utilizing available or desired ports in each one.

At block 504, the controller is communicatively coupled to the POS terminal 108. The secure data connection between the controller and the POS terminal 108 is established with at least one security protocol. The secure data connection may be a wired or wireless communication. The wireless connection may be provided with Bluetooth™, 802.1(x)(y), IR, near-field communication, or any other suitable wired or wireless two-way communication protocol. Security for the data exchanged between the POS terminal and the controller may be obtained via use of any secure encryption protocol such as AES-256, other private key encryption methods, public key infrastructure (“PKI”) methods, HTTPS, SSL, TLS, and other such security encryption protocols.

In the illustrative embodiment, there are three security operations performed to manage and control communications between the controller and the POS terminal 108. The at least two security operations also provide device authentication.

One security operation uses encryption to secure the communications between the POS terminal and the controller by way of example and not of limitation, the second security operation uses AES-256 encryption. AES-256 operates using a single private key, which is shared between the POS terminal and the controller.

Another security operation uses a proprietary security format. The illustrative proprietary security format may use packet length and a checksum function or checksum algorithm. The illustrative checksum functions are related to hash functions, fingerprints, randomization functions and cryptographic hash functions.

In one illustrative embodiment, the POS terminal 108 sends encrypted data using AES-256 encryption or PCI compliant Derived Unique Key Per Transaction (DUKPT) encryption, including all data containing patrons' PIN information.

At block 506, the controller is communicatively coupled to the backend server 114. The controller 102 is configured to connect to a database or database server, which provides logging, accounting, transactional management and reconciliation services. In the illustrative embodiment, the controller 102 is also communicatively coupled to backend server 114.

At block 508, the controller is communicatively coupled to the master gateway 118. At least one proprietary software application runs on the controller 102. By way of example and not of limitation, the proprietary software applications may include one or more application programming interface(s) required to access the master gateway 118 and financial network(s) through which EFT requests will be submitted and processed.

The method then proceeds to decision diamond 510, in which the data connections are monitored and authenticated. More specifically, the controller 102 and the data connections with the POS terminal 108, the master gateway 118 and the backend server 114 are constantly monitored. If a disconnection of the data connection is detected, then the transactional system automatically attempts to reconnect.

If any of the connections between the controller 102 and the POS terminal 108, the master gateway 118 and the backend server 114 are disconnected, then the method proceeds to block 512 and transactions cannot be processed.

The custom and proprietary software running on the controller continually performs a number of background processing functions. For example, at one second intervals, configuration information from the POS terminal 108, the controller 102, the printer 104, and all components and subsystems directly associated with those devices are read from the database server. Such data may include the name of the establishment, transaction fee amounts and the like. If any configuration changes are identified, the custom proprietary software running on the controller reconfigures any or all such data on the devices. Additionally, the status of the POS terminal 108 is also monitored, and in the event of connectivity or hardware failure, a connection to a replacement POS terminal may be initiated.

The controller 102 is also configured to perform other background processing functions including monitoring the connection to the database server and reestablish the connection if required. The controller 102 also requests the status of the dedicated printer 104 over the appropriate connection port, such as RS-232, to determine such factors as whether the printer is online or offline, the availability of sufficient paper in the printer, the presence of any paper jams or other adverse mechanical conditions, and the like. Additionally, the controller monitors the connection to the POS terminal 108 by polling the POS terminal 108. If no reply is received within a predetermined time, then the POS terminal 108 is either not present or not functional. Furthermore, the controller monitors the transaction database table resident on the backend server 114 for transactions that need to have a printed record operating as an indicia of value, such as tickets, or patron receipts reprinted. Further still, the controller 102 waits for transaction initiation requests from the POS terminal.

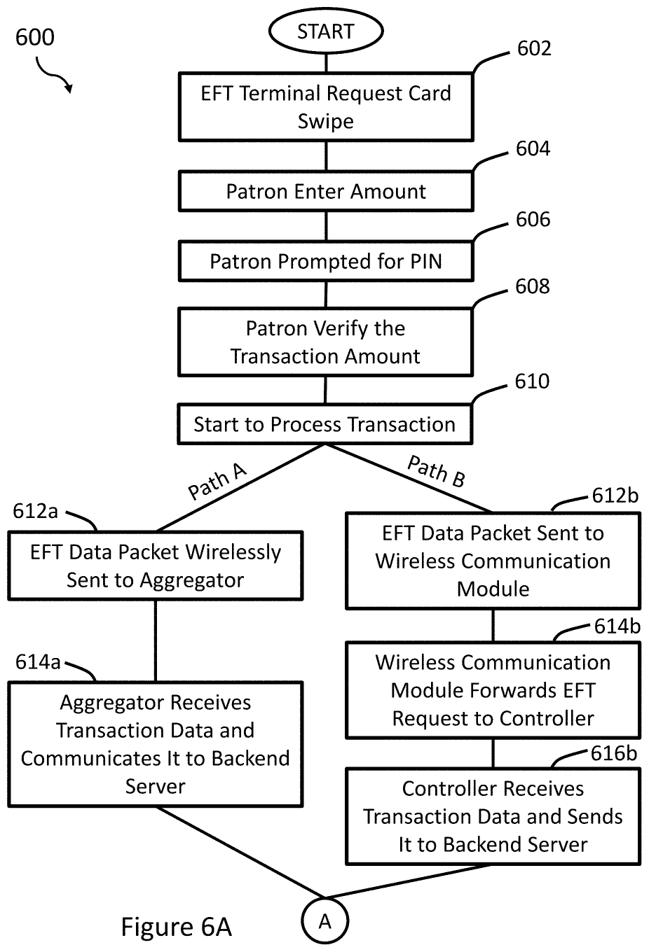

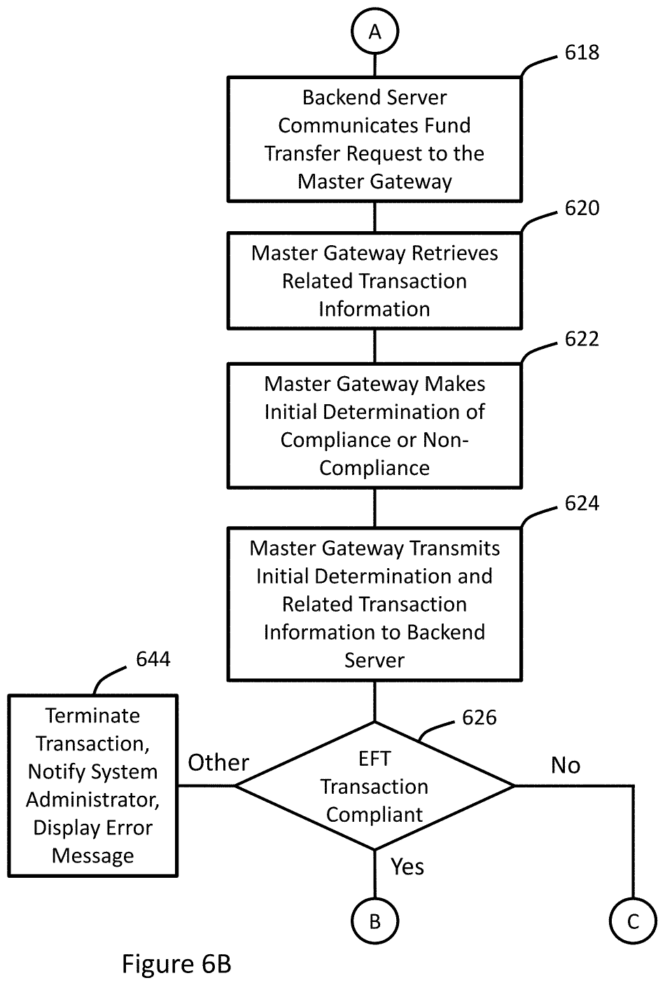

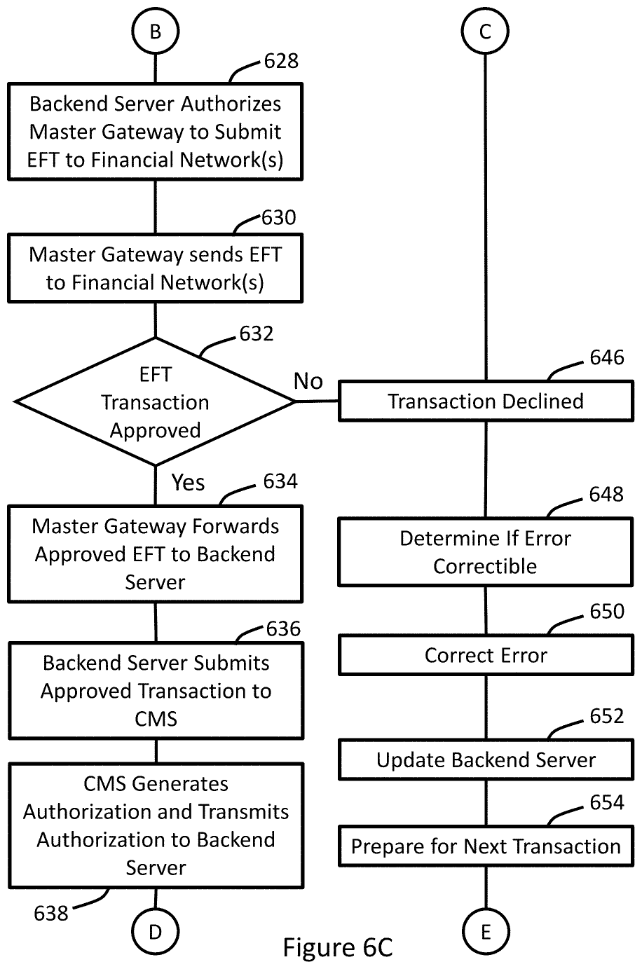

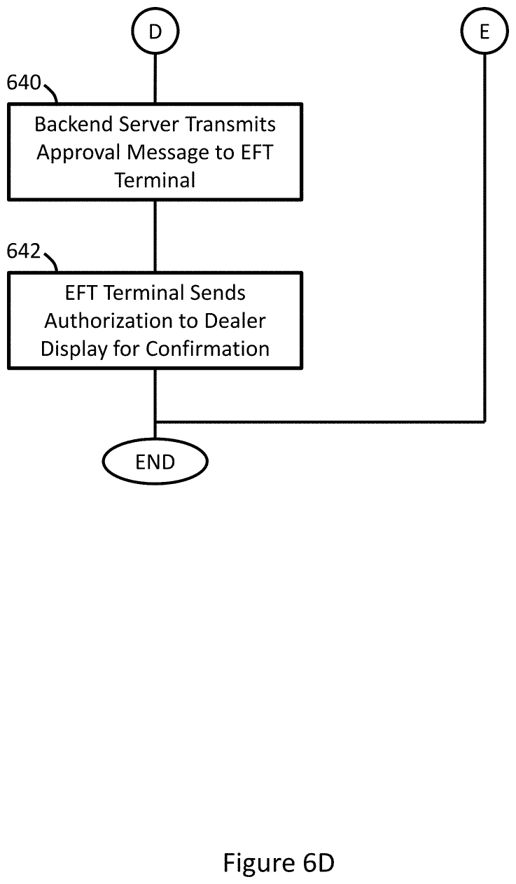

With reference now to FIG. 6A, there is shown a flowchart of an illustrative method 600 for initiating a transaction with an EFT terminal located at a table game 120, 130, 140, 150. The method is initiated at block 602 when the end user, e.g. casino patron, interacts with an EFT terminal using an electrically encoded card. By way of example and not of limitation, the electrically encoded card is a magnetically encoded card, e.g. a debit card.

In the illustrative embodiment, the patron obtains funds by swiping the patron's electrically encoded card, which is associated with the user's banking account, and enters information necessary to authenticate, define, and accept any associated terms of the transaction. For example, the custom and proprietary software running on the EFT terminal 108 displays and instructs the illustrative casino patron via a display with a command, such as “Swipe Card to Begin”. After the patron has swiped a card associated with an account which the patron owns or is authorized to access, the patron is then instructed to “Enter an Amount”.

The method then proceeds to block 604 where the end user, e.g. casino patron, enters the amount to withdraw. By way of example and not of limitation, the amount is checked by the EFT terminal software 115 for validity (too low, too high, zero), and if the requested amount is acceptable, the patron is then prompted to enter the PIN associated with the chosen account. The PIN data is received directly by the secure PCI-compliant software embedded in the EFT terminal 108 and is immediately secured via DUKPT encryption. In the illustrative embodiment, no other software or applications running on the EFT terminal 108 are granted access to the illustrative patron's encrypted PIN data.

At block 606, the end user is prompted for a PIN, which is typically associated with a debit card. The method then proceeds to block 608, where the end user verifies the transaction amount, the processing fee, convenience fee or other such fee associated with the transaction. The amount or rate of the fee may be shown to the patron in advance to comply with regulatory requirements pertaining to consumer financial transactions.

For example, following the successful receipt and encryption of the PIN data, the transaction fee is calculated by the custom and proprietary software running on the EFT terminal 108 based on data obtained from an SQL database resident on the illustrative database server. After the end user accepts the transaction and associated fee the method proceeds to block 610 where the transaction is processed.

After block 610, the method splits into two alternative paths for communication of an EFT request from the EFT terminal 108 to the backend server 114. Along Path A at block 612a, an appropriate data packet corresponding to the transaction is generated by the EFT terminal 108. The data packet is then communicated from the EFT terminal 108 to the aggregator 111 using a secure communications protocol as described previously. The aggregator 111 collects such data packets from one or more EFT terminals spread through a region or floor of a casino.

At block 614a, the aggregator 111 receives the transactional data, i.e. the fund transfer request, and communicates the transactional data to the backend server 114. In this Path A embodiment, the aggregator 111 is associated with one or more EFT terminals 108.

Alternatively, along Path B at block 612b, the appropriate data packet corresponding to the transaction is generated by the EFT terminal 108. The data packet is then communicated from the EFT terminal 108 to the wireless communication module 110 using a secure communications protocol as described previously.

At block 614b, the wireless communication module 110 communicates the transaction, i.e. fund transfer request, from the EFT terminal 108 to the controller 102. And at block 616b the controller 102 forwards/communicates the fund transfer request on to the backend server 114. The communication of the fund transfer request in blocks 614b and 616b may also be compressed into a single step where the communication of the fund transfer request is directly and wirelessly from the wireless communications module 110 to the backend server 114, instead of from the wireless communications module to the controller 102, then through a wired connection from the controller 102 to the backend server 114 as in blocks 614b and 616b. In the Path B embodiment, each wireless communication module 110 located in/at a particular gaming table may be associated with a particular EFT terminal.

Each of these alternate paths for the method for initiating a transaction permits end users, e.g. casino patrons, to draw funds electronically from a financial account which they own or are authorized to access, provided that the account has been enabled to permit such transactions. The transactional system and method presented herein may transfer funds from any account which permits such transfer via an electronic system or method provided that the patron has properly and independently established such ability in accordance with the requirements of the account administrator(s) in advance.

Referring to FIG. 6B, there is shown a continuation of the flowchart of the method 600 for initiating a transaction with the EFT terminal. The method then proceeds to block 618 where the backend server 114 communicates the transactional data to the master gateway 118. At block 620 the master gateway 118 retrieves transaction data for transactions related to the fund transfer request from a database associated with the master gateway 118. Related transactions can be previous transactions made by the same patron, previous transactions made by the same swipe or debit card, transactions made by the same patron or card occurring during a particular time period, e.g. within the last 24 hours. The selection of related transactions can be made based upon gaming limit and gaming rule factors for gaming limits and gaming rules that are potentially applicable to the location from which the electronic fund request was made, i.e. the casino property, the State, or Reservation. In an alternative embodiment, the master gateway 118 submits the fund transfer request to a financial network(s) as in block 528 prior to retrieving transaction data for transactions related to the fund transfer request. In the alternative embodiment, the master gateway 118 retrieves transaction data for transactions related to the fund transfer request and performs an initial determination of compliance or non-compliance with applicable gaming limits and gaming rules after receiving an approval of the fund transfer request from the financial network(s).

At block 622, the master gateway 118 makes an initial determination of whether the fund transfer request is compliant or non-compliant with the retrieved gaming limits and gaming rules based upon the transaction data associated with the fund transfer request, i.e. identity of patron making request, card used to make request, amount requested, time of request, and location of request, and the transactions related to the fund transfer request.

At block 624, the master gateway 118 transmits the initial determination of compliance or non-compliance, as well as the related transaction information and applicable gaming limits and gaming rules to the backend server 114 for an on-site determination of compliance or non-compliance.

At decision diamond 626, the backend server 114 performs an independent determination of whether the fund transfer request is compliant or non-compliant with the applicable gaming limits and gaming rules. The backend server 114 makes this compliance determination by comparing the received transaction data for transactions related to the fund transfer request and the applicable gaming limits and gaming rules in view of the temporal factors, geographic factors, and identity factors used to configure and define the gaming limits and gaming rules. This comparison can include totaling the value of the transactions related to the fund transfer request according to date, time, patron identity, card account, location of transaction, or any combination thereof.

If the backend server 114 determines that the fund transfer request is compliant with the applicable gaming limits and gaming rules, and this determination agrees with the master gateway initial determination, the method proceeds to block 628 in FIG. 6C. If the backend server 114 determines that the fund transfer request is non-compliant with the applicable gaming limits and gaming rules, and this determination agrees with the master gateway initial determination, the method proceeds to block 646 in FIG. 6D. However, if the backend server 114 determines either that the fund transfer request is compliant or non-compliant with the applicable gaming limits and gaming rules, but the determination does not agree with the master gateway initial determination, the method proceeds to block 644.

Referring to FIG. 6C, there is shown a continuation of the flowchart of the method 600 for initiating a transaction with the EFT terminal. At block 628 the backend server 114 authorizes the master gateway 118 to submit the fund transfer request to a financial network(s) for processing.

At block 630 the master gateway 118 sends the fund transfer request to a financial network(s) via a secure data communication connection and the response is received directly by the master gateway 118 from the financial network(s).

At decision diamond 632, the master gateway 118 receives either an approval or a disapproval for the fund transfer request from the financial network(s). Once the transaction request has been processed, the results of the transaction request are provided to the master gateway 118 from the appropriate financial server via the established interbank and financial network(s). Thus, if the transaction is approved, the method proceeds to block 622. And, if the transaction is declined at decision diamond 532, the method proceeds to block 646.

At block 634 the master gateway 118 passes the approved transaction record to the backend server 114. And at block 636 the backend server 114 submits the approved transaction record to the CMS 119 for creation of a corresponding transaction record in a database associated with the CMS 119. The transaction record stored in the database may include a time, date, amount, location, and patron identity.

At block 638 the CMS 119 generates a transaction authorization associated with the value of the fund transfer and transmits this transaction authorization to the backend server 114.

Referring to FIG. 6D, there is shown a continuation of the flowchart of the method 600 for initiating a transaction with the EFT terminal. At block 640 the backend server 114 transmits the transaction authorization and an “APPROVED” transaction message along either Path A or Path B back to the EFT terminal from which the fund transfer request was originally made. When the fund transfer request was originally created through Path A, the backend server 114 transmits the transaction authorization and the “APPROVED” transaction message through the aggregator 111 to the EFT terminal from which the patron made the fund transfer request. The EFT terminal then displays the “APPROVED” transaction message to the patron. When the fund transfer request was originally created through Path B, the backend server 114 transmits the transaction authorization and the “APPROVED” transaction message through the controller 102 and wireless communications module 110 to the EFT terminal from which the patron made the fund transfer request. As with Path A, the EFT terminal then displays the “APPROVED” transaction message to the patron.

At block 642 the backend server 114 transmits the transaction authorization to the table mounted display. As with block 640 this transmission path varies depending on whether the fund transfer request was originally made along Path A or Path B. When the fund transfer request was originally created through Path A, the backend server 114 transmits the transaction authorization to the table mounted display via the aggregator and the EFT terminal. When the fund transfer request was originally created through Path B, the backend server 114 transmits the transaction authorization to the table mounted display via the controller. When either Path A or Path B was utilized, the dealer or other casino employee then confirms the transaction by making or inputting a selection confirming the transaction at the display, i.e. by touching a touchscreen, prior to dispensing chips or other physical indicia to the patron at the table and terminating the method 600.

Referring back to decision diamond 626 in FIG. 6B, if the backend server 114 determines either that the fund transfer request is compliant or non-compliant with the applicable gaming limits and gaming rules, but the determination of the backend server 114 does not agree with the initial determination of the master gateway 118, the method proceeds to block 644. At block 644 the fund transfer request is terminated, the system administrator is notified of the inconsistent determinations, which are flagged for later review, and an error message is presented to the patron via the EFT terminal explaining that the fund transfer request was terminated due to a system error.

Again referring back to decision diamond 626 in FIG. 6B, if the backend server 114 determines that the fund transfer request is non-compliant with the applicable gaming limits and gaming rules, and this determination agrees with the master gateway initial determination, the method proceeds to block 646 in FIG. 6C.

Referring back to FIG. 6C, at block 646 the backend server 114 terminates the fund transfer request and sends a “DECLINED” transaction message to the patron via the aggregator 111, wireless communication module, and EFT terminal. The “DECLINED” transaction message is displayed to the patron on the EFT terminal. The particular declination message can include details about the declination, such as the gaming limit(s) or gaming rule(s) with which the patron's fund transfer request was non-compliant, codes corresponding to the reason for non-compliance, as well as times, locations, or amounts that would result in compliant fund transfer requests.

For example, if the transaction is declined, a data packet is sent to the EFT terminal to inform the patron via a LCD display on the EFT terminal that the transaction was not approved. Further a similar data packet is sent to the table mounted display to inform the dealer or casino employee that the transaction was not approved. Additionally, if the transaction has been declined, the patron receives notification of the unsuccessful result and may be prompted to repeat the process, possibly using a different account.

The method then proceeds to block 648, where an examination of the declined transaction is performed. At block 650, any correctible errors are corrected. Thus, each transaction record can be examined to determine the error, and then a determination of whether the error can either be automatically or manually corrected is made.

At block 652, the illustrative backend server 114 is updated to reflect any errors that have or have not been corrected. By way of example and not of limitation, after the transaction is declined, the appropriate errors or error corrections are reported and all software reverts back to the initial state and waits for the next transaction. The method then proceeds to block 654 where the transactional system is prepared for the next transaction.

Referring back to decision diamond 632 in FIG. 6C, if the transaction is declined at decision diamond 632, the method proceeds to block 646. At block 646 the backend server terminates the fund transfer request and sends a “DECLINED” transaction message to the patron via the aggregator 111, wireless communication module, and EFT terminal. The “DECLINED” transaction message is displayed to the patron on the EFT terminal. The backend server 114 also sends a “DECLINED” transaction message to the dealer or other casino employee via the aggregator 111, wireless communication module, and then displayed on the table mounted display. The particular declination message can include details about the declination, such as any reason or denial code provide by the financial network(s).

The transactional system and method described above may be used at a table game. The transactional system and method may also be utilized independently of any existing in-house data, communication, or financial network(s), including but not limited to a CMS 119. The accounting and financial reconciliation functions of the transactional system and method are configured to be exported to, combined with, or merged into any existing or envisioned CMS 119 provided by the establishment. However, CMS infrastructure is not required to be fully functional. Thus, the transactional system and method may be installed and operated, without the need for a CMS, an ERP system, or other such backend systems.

The transactional system and method provides a high level of security. More specifically, the transactional system and method provides a high level of electronic security for the end user's sensitive financial information. Additionally, the transactional system and method enables authorized personnel, e.g. system administrators, to manage and monitor the system remotely using standard computing hardware. Furthermore, the transactional system and method includes modular software and hardware components that support the system functionality with secure software and firmware. Further still, the transactional system and method utilizes secure firmware and software of the various components and sub-systems, and procuring any necessary approvals will be greatly simplified when compared with a system utilizing proprietary hardware devices.

The degree of software modularity for the transactional system may easily evolve as well to benefit from the improved performance and anticipated lower cost of the required hardware components.

It is to be understood that the detailed description of illustrative embodiments are provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A transactional system for a table game comprising:
a controller communicatively coupled to a wireless device, wherein the controller and wireless device are associated with the table game;
the wireless device receives at least one transactional input that initiates a transaction from the wireless device;
the wireless device communicates a plurality of transactional data to the controller, wherein the plurality of transactional data corresponds to the transaction initiated by the wireless device;
a database module communicatively coupled to the controller, the database module including a transaction record that is unique to the table game;
a payment gateway that is communicatively coupled to the controller, wherein the payment gateway communicates with at least one financial network;
the controller communicates the transactional data received from the wireless device to the payment gateway;
the controller receives an authorization response from the payment gateway for an approved transaction;
the controller communicates the authorization response to the database module;
the database module stores the authorization response in association with the transaction record that is unique to the table game;
the controller communicates the authorization response to the wireless device;
the controller generates a transaction summary for a time period;
the controller communicates the transaction summary for the time period to the database module; and
an indicia of the transaction summary.

2. The transactional system of claim 1 wherein the indicia of the transaction summary is an electronic record.

3. The transactional system of claim 1 further comprising a printer communicatively coupled to the controller, wherein the printer is associated with the table game.

4. The transactional system of claim 3 further comprising a housing enclosing the printer and the controller.

5. The transactional system of claim 4 wherein the housing is located at the table game.

6. The transactional system of claim 1 wherein the wireless device comprises an Electronic Funds Transfer (EFT) terminal that includes a card reader and a Personal Identification Number (PIN) pad, the card reader reads an electrically encoded card and the PIN pad receives a password corresponding to the electrically encoded card.

7. The transactional system of claim 6 wherein the electrically encoded card is a magnetically coded card.

8. The transactional system of claim 1 wherein the database module communicates with the controller, wherein the database module logs the transactional data communicated to the payment gateway and the authorization response associated with the approved transaction.

9. The transactional system of claim 8 further comprises a server communicatively coupled to a plurality of table games including the table game, the server includes the database module and the server communicates with a plurality of controllers, in which each controller is associated with a unique table game.

10. The transactional system of claim 1 wherein the database module generates the indicia of the transaction summary.

11. The transactional system of claim 3 wherein the printer is communicatively coupled to the controller, and wherein the printer is accessible by a plurality of table games.

12. The transactional system of claim 10 wherein the indicia of the transaction summary is printed from a remote server.

13. The transactional system of claim 10 wherein the indicia of the transaction summary is printed at the table game.

14. The transactional system of claim 1 wherein the receipt corresponding to the approved transaction is printed by the wireless device.

15. The transaction system of claim 1 further comprising a display communicatively coupled to the controller, wherein the display is associated with the table game.

16. A transactional method for a table game, the transactional method comprising:
communicatively coupling a controller to a wireless device, wherein the controller and wireless device are associated with the table game;
receiving, by the wireless device, at least one transactional input that initiates a transaction from the wireless device;
communicating a plurality of transactional data from the wireless device to the controller, wherein the plurality of transactional data corresponds to the transaction initiated by the wireless device;
communicatively coupling a database module to the controller, wherein the database module includes a transaction record that is unique to the table game;
communicatively coupling a payment gateway to the controller, wherein the payment gateway communicates with at least one financial network;
communicating the received transactional data from the controller to the payment gateway;
receiving an authorization response from the payment gateway for an approved transaction at the controller;
communicating the authorization response from the controller to the database module;
storing, by the database module, the authorization response in association with the transaction record that is unique to the table game;
communicating the authorization response from the controller to the wireless device; and
generating, by the controller, a transaction summary for a time period.

17. The transactional method of claim 16 further comprising:
communicating the transaction summary for the time period to the database module; and
generating an indicia of the transaction summary.

18. The transactional method of claim 16 further comprising communicatively coupling a printer and the controller.

19. The transactional method of claim 18 further comprising enclosing the printer and the controller in a housing.

20. The transactional method of claim 19 wherein the housing is located at the table game.

21. The transactional method of claim 16 wherein the wireless device comprises an Electronic Funds Transfer (EFT) terminal that includes a card reader and a Personal Identification Number (PIN) pad, wherein the card reader reads an electrically encoded card and the PIN pad receives a password corresponding to the electrically encoded card.

22. The transactional method of claim 21 wherein the electrically encoded card is a magnetically encoded card.

23. The transactional method of claim 16 further comprising logging, by the database module, the transactional data communicated to the payment gateway and the authorization response associated with the approved transaction.

24. The transactional method of claim 23 further comprises communicatively coupling a server to a plurality of table games, wherein the server includes the database module and the server communicates with a plurality of controllers, in which each controller is associated with a table game.

25. The transactional method of claim 18 wherein the printer is communicatively coupled to the controller, and wherein the printer is accessible by a plurality of table games.

26. The transactional method of claim 17 wherein the indicia of the transaction summary is an electronic record.

27. The transactional method of claim 17 wherein the indicia of the transaction summary is a printed record.
